(19) United States
(12) Patent Application Publication
(10) Pub. No.: US 2013/0145552 A1
(43) Pub. Date: Jun. 13, 2013

(54) VARIABLE-SHAPE SEATING SURFACE

(71) Applicants: Aziz A. Bhai, West Chester, OH (US); Mark E. Lanning, Mt. Pleasant, SC (US)

(72) Inventors: Aziz A. Bhai, West Chester, OH (US); Mark E. Lanning, Mt. Pleasant, SC (US)

(21) Appl. No.: 13/314,501

(22) Filed: Dec. 8, 2011

(51) Int. Cl. A61G 7/015; A61G 7/018

(52) U.S. Cl. 5/624

(57) ABSTRACT

A patient support apparatus includes a deck, a support structure supported on the deck, and a control system. The deck includes a head deck section and a seat deck section. The head deck section is movable between a lowered position and a raised position. The support structure is supported on the deck and includes a variable-shape cushion that is selectively configurable to a plurality of shapes. The control system coordinates configuration of the variable-shape cushion with movement of the head deck section such that movement of the head deck section upwardly causes the variable-shape cushion to be configured to resist shifting of a patient's buttocks

### BACKGROUND

The present invention relates generally to patient supports. More specifically, the present invention relates to patient supports including movable head sections configured to reposition a patient supported on the patient support. Sometimes, movement of the head section of a patient support to reposition a patient may result in undesirable secondary movement of the patient along the patient support.

### SUMMARY

The present application discloses one or more of the features recited in the appended claims and/or the following features which alone or in any combination, may comprise patentable subject matter.

A patient support apparatus may include a deck, a support structure, and a control system. The deck may include a seat deck section and a head deck section movable between a lowered position and a raised position. The support structure may be supported on the deck and may include a variable-shape cushion. The variable-shape cushion may be selectively configurable to a plurality of shapes. The control system may coordinate configuration of the variable-shape cushion with movement of the head deck section between the lowered position and the raised position such that movement of the head deck section upwardly causes the variable-shape cushion to be configured to resist shifting of a patient's buttocks.

In some embodiments, the apparatus may also include a lower frame and an upper frame movable relative to the lower frame. The deck may be supported on the upper frame for pivotal movement relative thereto.

The control system may coordinate the configuration of the variable-shape cushion such that the variable-shape cushion is no longer in a configuration to resist shifting of a patient's buttocks after termination of the upward movement. In some embodiments, the control system may coordinate configuration of the variable-shape cushion such that the variable-shape cushion remains in a configuration to resist shifting of a patient's buttocks until the head deck section returns to the lowered position. In some embodiments, the control system may coordinate configuration of the variable-shape cushion with the movement of the head deck section such that the degree of variation of the variable-shape cushion is proportional to the angle between the head deck section and the seat deck section.

It is contemplated that the variable-shape cushion may include at least one inflatable bladder. The control system may include a controller and an air system having a source of pressurized air, a manifold, and an exhaust, the control system configured to control flow of air from the source of pressurized air through the manifold to the variable-shape cushion. The control system may coordinate inflation of the bladder with movement of the head deck section.

The at least one inflatable bladder of the variable-shape cushion may include a plurality of transversely oriented bladders. The plurality of transversely oriented bladders may be inflated to varying degrees such that the upper surface of the seat-support section forms an incline such that the portion of the surface of the seat-support section nearest the foot end of the patient support apparatus is higher than the portion of the surface of the seat-support section nearest the head end of the patient support apparatus.

In another embodiment, a patient support apparatus may include a deck, a support structure, and a control system. The deck may include a head deck section and a seat deck section. The support structure may be supported on the deck. The support structure may include a variable-shape cushion that is selectively configurable to a plurality of shapes. The control system may coordinate configuration of the variable-shape cushion with movement of the head deck section to a plurality of positions between a lowered position and a raised position such that the variable-shape cushion forms a wave front shifting a patient's buttocks toward the head support section.

In some embodiments, the apparatus may also include a lower frame and an upper frame movable relative to the lower frame. The deck may be supported on the upper frame for pivotal movement relative thereto.

The control system may coordinate configuration of the variable-shape cushion to cycle once to shift a patient's buttocks when the position of the head deck section exceeds a threshold angle relative to the upper frame. In some embodiments, the control system may coordinate configuration of the variable-shape cushion to intermittently cycle to shift a patient's buttocks when the position of the head deck section exceeds a threshold angle relative to the upper frame. In some embodiments, the control system may coordinate configuration of the variable-shape cushion to continuously cycle to shift a patient's buttocks when the position of the head deck section exceeds a threshold angle relative to the upper frame.

It is contemplated that the variable-shape cushion may include at least one inflatable bladder. The control system may include a controller and an air system including a source of pressurized air, a manifold, and an exhaust. The controller may be configured to control flow of air from the source of pressurized air through the manifold to the variable-shape cushion.

The variable-shape cushion may include a plurality of transversely oriented bladders. The transversely oriented bladders may be inflated sequentially beginning at an end of the variable-shape cushion closest to the foot-support section and reaching an end point prior to the bladder closest to the head-support section. Each bladder may be deflated after a time so that the upper surface of the seat-support section forms a wave front that moves from the end of the seat-support section closest to the foot support section toward the end of the seat-support section closest to the head support section.

At least one inflatable bladder of the variable-shape cushion closest to the head support section may be deflated. Deflation of the at least one inflatable bladder of the variable-shape cushion closest to the head support section may result in lowering of that portion of the top surface of the variable-shape cushion with respect to the rest of the top surface.

Additional features and advantages of the invention will become apparent to those skilled in the art upon consideration of the following detailed description of illustrated embodiments exemplifying the best mode of carrying out the invention as presently perceived.

### BRIEF DESCRIPTION OF THE DRAWINGS

The detailed description of the drawings particularly refers to the accompanying figures in which:

FIG. 1 is a perspective view of a patient support apparatus comprising a frame with a deck and a support structure overlying the deck;

FIG. 2 is a side elevation view of the patient support apparatus shown in FIG. 1 showing that the support structure includes a head bladder, a variable-shape seat cushion with a four seat bladders, a thigh bladder, and a foot bladder;

FIG. 3 is a top plan view of the support structure of FIG. 2, showing that the four seat bladders are oriented transverse to the longitudinal axis of the support structure;

FIG. 4 is a diagrammatic view of the patient support apparatus of FIG. 1 showing that the patient support apparatus includes a control system with a deck positioning system, an air distribution system, and a controller;

FIG. 5 is a partial side elevation view of a portion of the patient support apparatus of FIGS. 1-4 wherein the deck includes a seat deck section and a head deck section showing the head deck section in a lowered position;

FIG. 6 is a partial side elevation view of a portion of the patient support apparatus of FIG. 5 showing the head deck section in a raised position;

FIG. 7 is a partial side elevation view of the support structure of FIG. 5 showing the variable-shape seat cushion in a substantially flat configuration;

FIG. 8 is a partial side elevation view of the support structure of FIG. 7 showing the head-supporting section of the support structure inclined a first amount relative to the seat-supporting section and the variable-shape seat cushion reconfigured to form a wedge to resist movement of a patient's buttocks toward the foot end of the patient support apparatus;

FIG. 9 is a partial side elevation view of the support structure of FIG. 8 showing the head-supporting section of the support structure inclined a second amount relative to the seat-supporting section and the variable-shape seat cushion reconfigured to form a wedge proportional to the incline of the head-supporting section;

FIG. 10 is a partial side elevation view of the support structure of FIG. 5 showing the head bladder of the support structure inclined relative to the variable-shape seat cushion and the variable-shape seat cushion reconfigured to form a wave front;

FIG. 11 is a partial side elevation view of the support structure of FIG. 10 showing the variable-shape seat cushion reconfigured to move the wave front toward the head bladder; and

FIG. 12 is a partial side elevation view of the support structure of FIG. 11 showing the variable-shape seat cushion reconfigured to reduce the wave front prior to the variable-shape seat cushion returning to a substantially flat configuration.

### DETAILED DESCRIPTION OF THE DRAWINGS

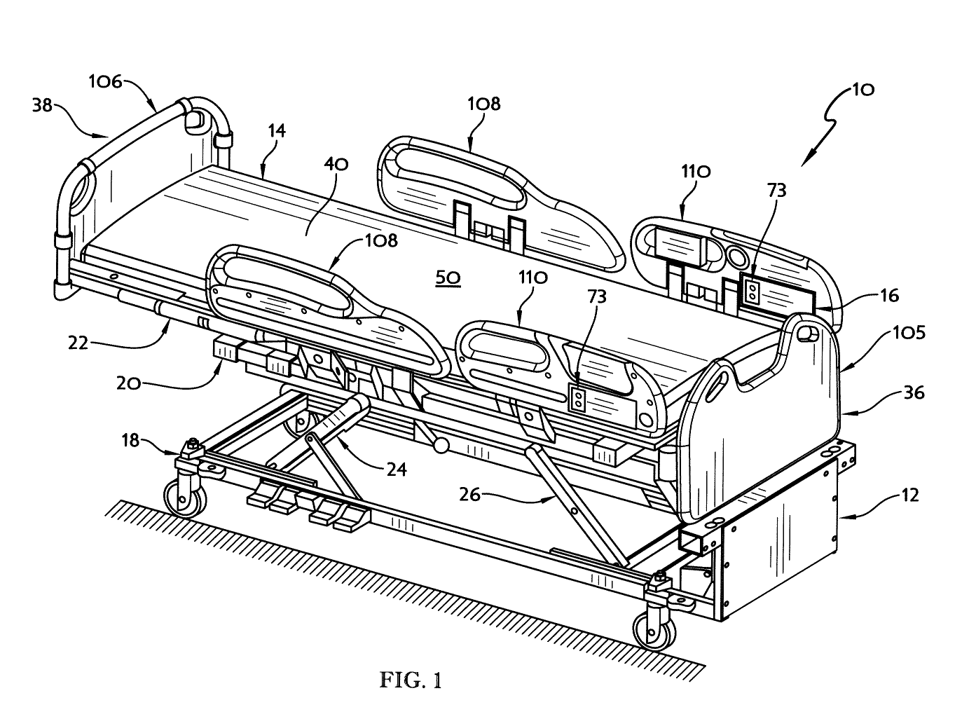

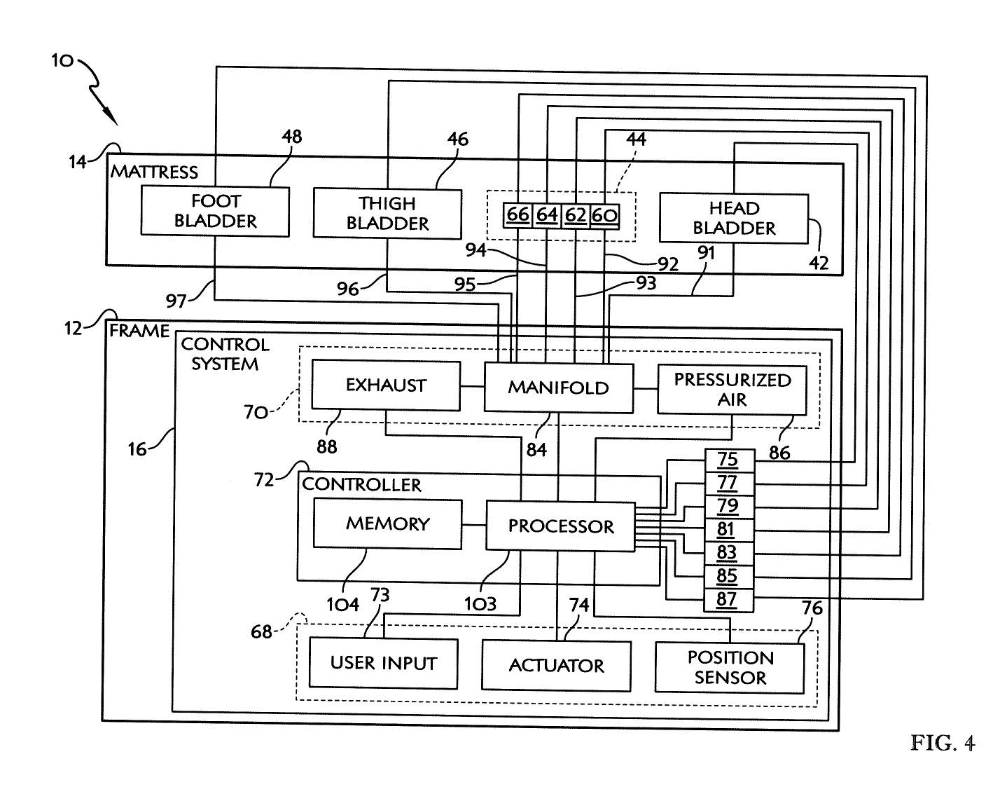

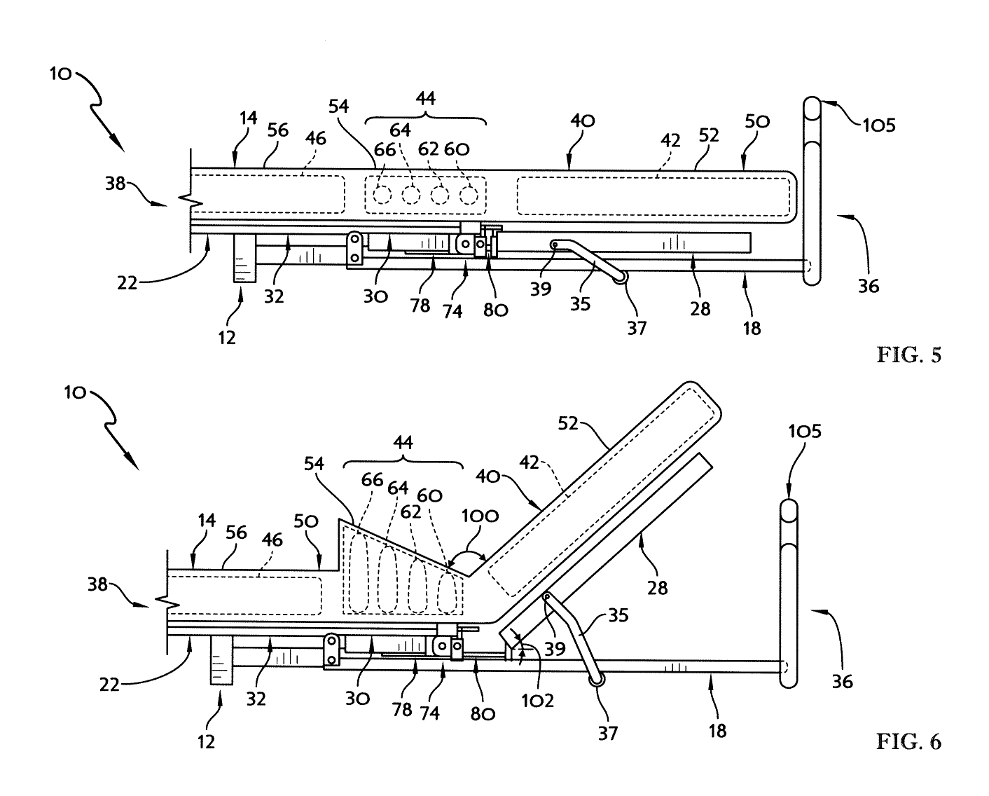

A patient support apparatus is illustratively embodied as a hospital bed 10 as shown in FIG. 1. The bed 10 includes a frame 12, a mattress 14 supported on the frame 12, and a control system 16. The bed 10 is illustratively movable between a flat configuration, shown in FIG. 5, and an inclined configuration, as shown in FIG. 6. The mattress 14 is operated by the control system 16 to cause the mattress 14 to resist shifting of a patient's buttocks in response to movement of the bed from the flat configuration to the inclined configuration.

The frame 12 of the bed 10 is configured to support the mattress 14 and illustratively includes a lower frame 18, an upper frame 20, and a deck 22 as shown in FIG. 1. The lower frame 18 is coupled to the upper frame 20 by a first pair of lift arms 24 and a second pair of lift arms 26. The lift arms 24, 26 are configured to raise and lower the upper frame 20 relative to the lower frame 18. The deck 22 is coupled to the upper frame 20 for movement with the upper frame 20 relative to the lower frame 18.

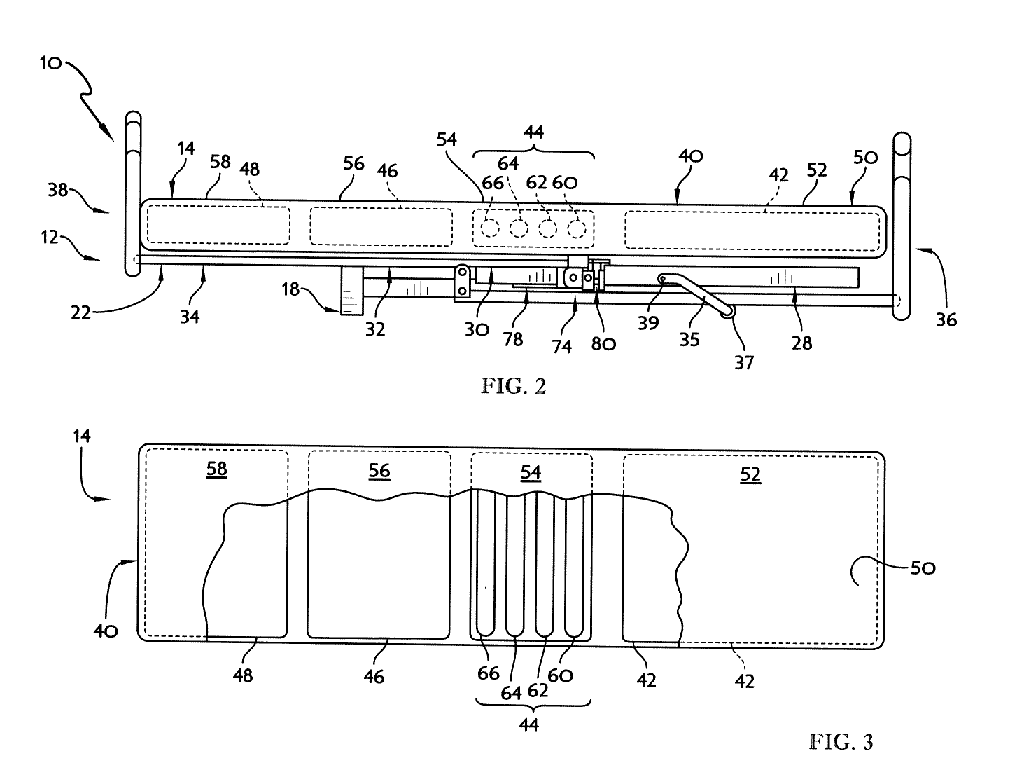

The deck 22 of the frame 12 underlies and contacts the mattress 14 so that the mattress 14 is reconfigured in response to movement of the deck 22 as shown in FIG. 6. The deck 22 illustratively includes a head deck section 28, a seat deck section 30, a thigh deck section 32, and a foot deck section 34 as shown, for example, in FIG. 2. The head deck section 28 is located at a head end 36 of the bed 10 and is illustratively coupled to the upper frame 20 of the patient support by a guide arm 35 as shown in FIG. 2. The guide arm 35 is pivotably coupled at a first end 37 to the upper frame 20 and at a second end 39 to the head deck section 28. The seat deck section 30 is situated between the head deck section 28 and the thigh deck section 32. The thigh deck section 32 is situated between the seat deck section 30 and the foot deck section 34. The foot deck section 34 is located near a foot end 38 of the bed 10.

The mattress 14 illustratively includes an outer ticking 40, a head bladder 42, a variable-shape seat cushion 44, a thigh bladder 46, and a foot bladder 48 as shown in FIG. 3. The outer ticking 40 houses the head bladder 42, the variable-shape seat cushion 44, the thigh bladder 46, and the foot bladder 48. The head bladder 42 is configured to support the head and torso of a patient located on the bed 10. The variable-shape seat cushion 44 is configured to support the buttocks of a patient located on the bed 10. The thigh bladder 46 is configured to support the thighs of a patient located on the bed 10. The foot bladder 48 is configured to support the lower legs and feet of a patient located on the bed 10.

The mattress 14 has a top surface 50 illustratively divided into a head-supporting section 52, a seat-supporting section 54, a thigh-supporting section 56, and a foot-supporting section 58 as shown, for example, in FIGS. 2 and 3. The head-supporting section 52 is generally defined by the head bladder 42 and is located to be generally supported by the head deck section 28 of the deck 22. The seat-supporting section 54 is generally defined by the variable-shape seat cushion 44 and is configured to be generally supported by the seat deck section 30 of the deck 22. The thigh-supporting section 56 is generally defined by the thigh bladder 46 and is configured to be generally supported by the thigh deck section 32 of the deck 22. The foot-supporting section 58 is generally defined by the foot bladder 48 and is configured to be generally supported by the foot deck section 34 of the deck 22.

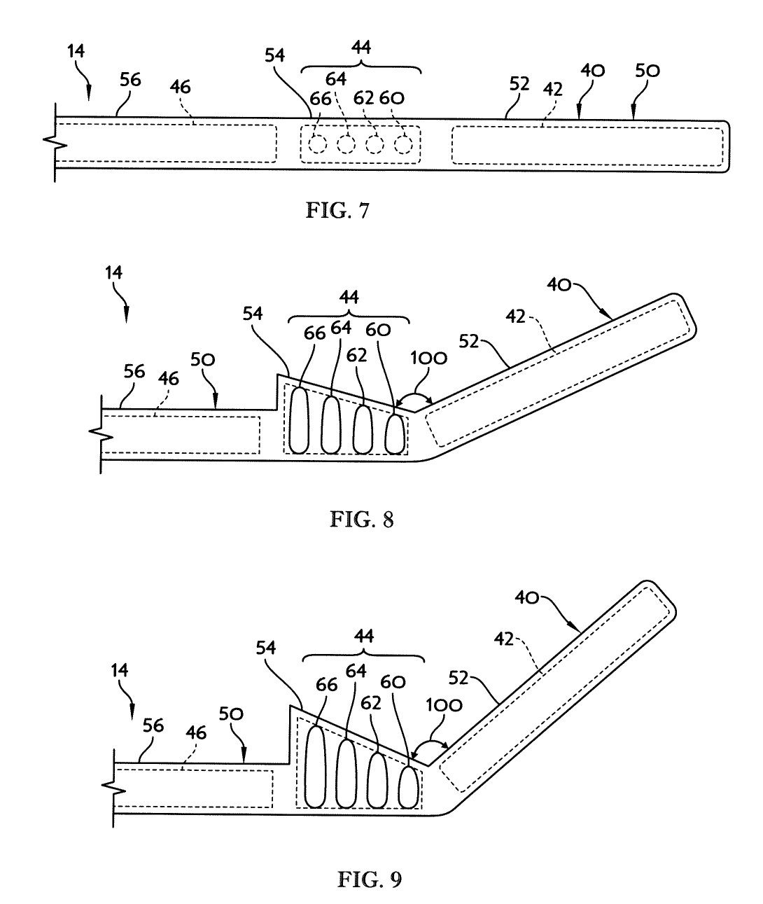

The variable-shape seat cushion 44 is operable by the control system to vary in shape depending on the configuration of the deck 22 as shown, for example in FIGS. 7-9. The variable-shape seat cushion 44 illustratively includes a first seat bladder 60, a second seat bladder 62, a third seat bladder 64, and a fourth seat bladder 66 as shown, for example in FIG. 3. The seat bladders 60, 62, 64, 66 are illustratively oriented transverse to the longitudinal axis of the mattress 14 and the bed 10. In other embodiments, more, or less, than four seat bladders may be used.

The control system 16 is illustratively housed in the frame 12 of the bed 10 and is operatively coupled to the mattress 14 as shown, diagrammatically, in FIG. 4. The control system 16 includes a deck positioning system 68, an air distribution system 70, a plurality of pressure sensors 75, 77, 79, 81, 83, 85, 87, and a controller 72. The deck positioning system 68 is configured to move the head deck section 28 of the deck 22 between a lowered position, shown in FIG. 5, and a raised position, shown in FIG. 6. The air distribution system 70 is configured to inflate and deflate the mattress 14 to support a patient located on the mattress 14. The controller 72 is configured to control the movement of the head deck section 28 of the deck 22 and to control the shape of the seat-supporting section 54 of the mattress 14 to resist shifting of a patient's buttocks when the head-supporting section 52 of the mattress 14 is moved with the head deck section 28.

Each of the pressure sensors 75, 77, 79, 81, 83, 85, 87 is pneumatically coupled to one of the bladders 42, 46, 48, 60, 62, 64, 66 to measure pressure in each bladder in parallel as shown, for example, in FIG. 4. In other embodiments, one or more pressure sensors may be used and switched between the bladders 42, 46, 48, 60, 62, 64, 66 to measure pressure in each bladder in series. Each of the pressure sensors 75, 77, 79, 81, 83, 85, 87 is electrically coupled to the controller 72 to provide pressure information from each bladder to the controller 72.

The controller 72 illustratively includes a processor 103 and a memory 104 including instructions to be read and performed by the processor 103. The processor 103 receives inputs from the user input 73, the position sensor 76, and the pressure sensors 75, 77, 79, 81, 83, 85, 87. The processor 103 then outputs directions to the linear actuator 74, the manifold 84, the pressurized air source 86, and the exhaust 88 based on instructions from the memory 104.

The deck positioning system 68 illustratively includes a user input 73, a linear actuator 74, and a position sensor 76 as shown diagrammatically in FIG. 4. The user input 73 is in electrical communication with the controller 72 and is illustratively a switch mounted on the frame 12 of the bed 10. In other embodiments, the user input 73 may be a touch screen, at least one button, or another suitable input. The linear actuator 74 is illustratively configured to extend and retract to move the head deck section 28 to a plurality of locations between the lowered position and the raised position. The position sensor 76 is configured to provide information related to the position of the head deck section 28 relative to the seat deck section 30. The position sensor 76 is illustratively coupled to the linear actuator 74 and is a potentiometer. In other embodiments, the position sensor 76 may be an accelerometer coupled to the head deck section 28 and configured to measure the position of the head deck section 28 using gravitational effects.

The linear actuator 74 is illustratively coupled to the upper frame 20 of the bed 10 and contacts the foot end of head deck section 28 as shown, for example, in FIGS. 5 and 6. The linear actuator 74 includes a cylinder 78 and a shaft 80 that extends and retracts relative to the cylinder 78. The linear actuator 74 is operably coupled to controller 72. The controller 72 directs the linear actuator 74 to extend and retract in response to a user selecting a movement or configuration of the head deck section 28 from the user input 73.

The lowered position of the head deck section 28 is achieved when the linear actuator 74 is fully retracted as shown, for example, in FIG. 5. When the head deck section 28 is in the lowered position, the end closest to the foot end 38 of the head deck section 28 is adjacent to the seat deck section 30 and is parallel with the linear actuator 74.

One raised position of the head deck section 28 is achieved when the linear actuator 74 is fully extended as shown, for example, in FIG. 6. When the head deck section 28 is in the raised position, the foot end of the head deck section 28 is spaced from the seat deck section 30 and the head deck section 28 forms an angle 102 with the with the upper frame 20 as shown in FIG. 6. Additional raised positions are achieved when the linear actuator 74 is extended out from the fully retracted position so that the foot end of the head deck section 28 is spaced some distance from the seat deck section 30 and the head deck section 28 forms an angle with the linear actuator 74.

The air distribution system 70 illustratively includes a manifold 84, a pressurized air source 86, and an exhaust 88 as shown diagrammatically in FIG. 4. The manifold 84 is operably coupled to the controller 72, the pressurized air source 86, and the exhaust 88. The pressurized air source 86 is illustratively an air compressor but in other embodiments may be a compressed air cylinder or other liquid or gas source. The pressurized air source 86 is electrically coupled to the controller 72 and may be turned on and off in response to directions from the controller 72. The exhaust 88 is illustratively a vent to the atmosphere but in other embodiments may be a connection to a low pressure liquid or gas reservoir.

The manifold 84 is configured to seal off or selectively connect the bladders 42, 46, 48, 60, 62, 64, 66 of the mattress 14 to the pressurized air source 86 or the exhaust 88. The manifold 84 illustratively includes a plurality of valves (not shown) each operably coupled to the controller 72 to be opened and closed. The manifold 84 further includes a plurality of pressure sensors (not shown) in communication with the controller 72 and configured to transmit information related to the pressure in each of the bladders 42, 46, 48, 60, 62, 64, 66 in the mattress 14. The manifold 84 is illustratively fluidly coupled to each of the bladders 42, 46, 48, 60, 62, 64, 66 in the mattress 14 by independent conduits 91, 92, 93, 94, 95, 96, 97 as shown in FIG. 4.

The controller 72 is configured to receive information relating to the head deck section 28 position from the position sensor 76 and to direct the variable-shape seat cushion 44 to change shape in response to the head deck section 28 position. The controller 72 is configured to change the shape of the variable-shape seat cushion 44 by increasing the pressure in some of the seat bladders 60, 62, 64, 66 relative to others of the seat bladders 60, 62, 64, 66. Illustratively, the controller 72 directs the variable-shape cushion 44 to change shape by receiving pressure information about each seat bladder 60, 62, 64, 66 from the pressure sensors 77, 79, 81, 83 coupled to the seat bladders 60, 62, 64, 66. The controller 72 then directs the manifold 84 to couple individual seat bladders 60, 62, 64, 66 to either the pressurized air source 86 to increase the pressure in the individual bladder or to the exhaust 88 to decrease pressure in the individual bladder. The controller 72 directs the manifold 84 to seal the seat bladders 60, 62, 64, 66 when the controller 72 receives inputs from the pressure sensors 77, 79, 81, 83 that correspond to a desired shape profile of the variable-shape seat cushion 44.

The frame 12 also includes a head board 105, a footboard 106, side rails 108, and head rails 110 as shown, for example, in FIG. 1. The head board 105 is coupled to the upper frame 20 and blocks patient egress along the head end 36 of the bed 10. The footboard 106 is coupled to the foot deck section 34 of deck 22 and extends along the foot end 38 of the bed 10. The side rails 108 extend along the seat and thigh-supporting sections 54, 56 of the mattress 14 to block patient egress. The head rails 110 extend along the head-supporting section 52 of the mattress 14 and are coupled to the head deck section 28 of the deck 22. The user input 73 is illustratively coupled to the head rail 110 as shown in FIG. 1.

In a first mode of operation, the controller 72 is configured to change the shape of the variable-shape seat cushion 44 so that the seat-supporting section 54 of the mattress 14 resists movement of a patient's buttocks toward the foot end 38 of the bed 10 when the head deck section 28 stops in a desired raised position as shown, for example, in FIGS. 8 and 9. Specifically, when the head deck section 28 is moved to a desired raised position as measured by the position sensor 76 and stops in the desired raised position for a period of time, the controller 72 directs the manifold 84 to operate such that the variable-shape seat cushion 44 forms a wedge so that the seat-supporting section 54 of the mattress 14 is configured to resist movement of a patient's buttocks toward the foot end 38 of the bed 10. The controller 72 directs the manifold 96 to maintain the variable-shape seat cushion 44 in the wedge shape until the head deck section 28 returns to the lowered position.

Illustratively, a pressure profile corresponding to the wedge shape of the variable-shape cushion 44 is attained by at least one of the seat bladders 60, 62, 64, 66 being selectively coupled to the pressurized air source 86 or the exhaust 88 so that the bladder 60 has less pressure than the bladder 62, the bladder 62 has less pressure than the bladder 64, and the bladder 64 has less pressure than bladder 66. In response to the pressure profile obtained in the seat bladders 60, 62, 64, 66 of the variable-shape seat cushion 44, the variable-shape seat cushion 44 forms the wedge shape wherein the seat bladder 66 is taller than the seat bladder 64, the seat bladder 64 is taller than the seat bladder 62, and the seat bladder 62 is taller than the seat bladder 60 as shown, for example, in FIG. 9. When the variable-shape seat cushion 44 forms the wedge shape, an angle 100 is formed between the head-supporting section 52 and the seat-supporting section 54 of the mattress 14. Angle 100 is illustratively smaller than the incline angle 102 of the head deck section 28 relative to the upper frame 20 so that the variable-shape seat cushion 44 resists movement of a patient's buttocks toward the foot end 38 of the bed 10.

In some embodiments, the controller 72 directs the manifold 84 to inflate (or deflate) the seat bladders 60, 62, 64, 66 of the variable-shape seat cushion 44 so that the variable-shape seat cushion 44 forms an angle 100 proportional to the incline angle 102 of the head deck section 28 as shown, for example, in FIG. 8. As the head deck section 28 is moved to increase the angle 102 between the head deck section 28 and the upper frame 20, a patient's torso moves along with the head-supporting section 52 of the mattress 14 so that forces encouraging the patient's buttocks toward the foot end 38 of the bed 10 increase. In some embodiments, the controller 72 is configured to incrementally modify the angle 100 between the seat-supporting section 54 and the head-supporting section 52 of the mattress 14 when the head deck section 28 stops at a desired raised position by inflating (or deflating) the variable-shape cushion 44 so that forces encouraging the patient's buttocks toward the foot end 38 of the bed 10 are resisted.

Illustratively, the controller may direct the manifold to inflate (or deflate) the seat bladders 60, 62, 64, 66 of the variable-shape seat cushion 44 so that the angle 100 between the head-supporting section 52 and the seat-supporting section 54 is reduced as the angle 102 between the head deck section 28 and the upper frame 20 is increased. Conversely, the controller may direct the manifold to inflate (or deflate) the seat bladders 60, 62, 64, 66 of the variable-shape seat cushion 44 so that the angle 100 between the head-supporting section 52 and the seat-supporting section 54 is increased as the angle 102 between the head deck section 28 and the upper frame 20 is decreased.

In a second mode of operation, the controller 72 is configured to change the shape of the variable-shape seat cushion 44 so that the seat-supporting section 54 of the mattress 14 resists movement of a patient's buttocks toward the foot end 38 of the bed 10 during movement of the head deck section 28 away from the lowered position, shown in FIG. 5, toward a desired raised position, shown in FIG. 6. Specifically, when the head deck section 28 begins moving away from the lowered position and toward the desired raised position as measured by the position sensor 76, the controller 72 directs the manifold 84 to operate so that the variable-shape seat cushion 44 begins to form a wedge so that the seat-supporting section 54 of the mattress 14 is configured to resist movement of a patient's buttocks toward the foot end 38 of the bed 10 while the head-supporting section 52 of the mattress 14 is moving upwardly. The controller 72 directs with the manifold 96 to maintain the variable-shape seat cushion 44 in the wedge shape to resist movement of a patient's buttocks toward the foot end of the bed 10 until the head deck section 28 returns to the lowered position. In other embodiments, the controller 72 directs the manifold 96 to maintain the wedge shape until the head deck section 28 reaches to the raised position when the controller directs the variable-shape seat cushion 44 to return to a substantially flat configuration. The wedge shape formed during movement of the head deck section 28 toward the raised position is illustratively accomplished in a manner substantially similar to that described with regard to the first mode of operation.

In some embodiments of the second mode of operation, the controller 72 directs the manifold 84 to inflate (or deflate) the seat bladders 60, 62, 64, 66 of the variable-shape seat cushion 44 so that the variable-shape seat cushion 44 forms an angle 100 proportional to the incline angle of the head deck section 28 dynamically changing as the head deck section 28 moves. The controller 72 illustratively directs the variable-shape cushion 44 to incrementally modify the angle 100 between the seat-supporting section 54 and the head-supporting section 52 of the mattress 14 by inflating (or deflating) the variable-shape cushion 44 so that forces encouraging the patient's buttocks toward the foot end 38 of the bed 10 are resisted as the head deck section 28 moves away from the lowered position toward the fully raised position. Illustratively, the controller may direct the manifold to inflate (or deflate) the seat bladders 60, 62, 64, 66 of the variable-shape seat cushion 44 so that the angle 100 between the head-supporting section 52 and the seat-supporting section 54 is reduced as the angle 102 between the head deck section 28 and the upper frame 20 is increased. Conversely, the controller may direct the manifold to inflate (or deflate) the seat bladders 60, 62, 64, 66 of the variable-shape seat cushion 44 so that the angle 100 between the head-supporting section 52 and the seat-supporting section 54 is increased as the angle 102 between the head deck section 28 and the upper frame 20 is decreased.

In some embodiments of the second mode of operation, the controller 72 may direct the manifold 84 to return the seat bladders 60, 62, 64, 66 of the variable-shape seat cushion 44 to a substantially equalized pressure after the head deck section 28 reaches a desired raised position. Equalization of the pressures in the seat bladders 60, 62, 64, 66 results in the variable-shape seat cushion 44 returning to a relatively flat configuration.

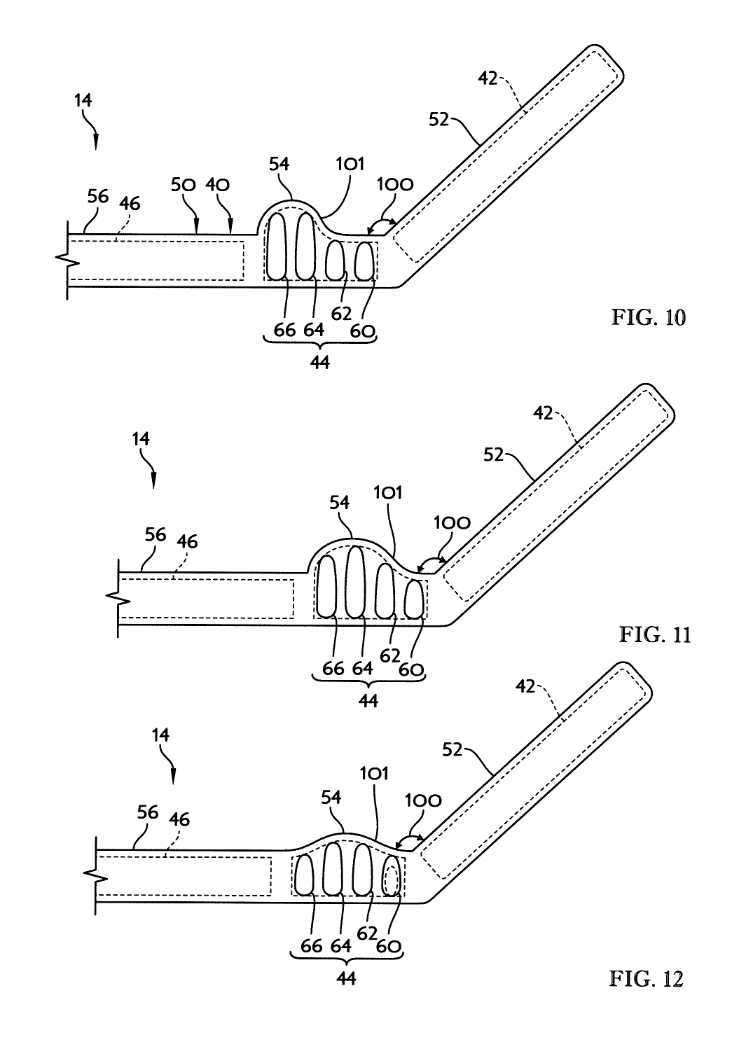

In a third mode of operation, the controller 72 is configured to dynamically change the shape of the variable-shape seat cushion 44 so that the seat-supporting section 54 of the mattress 14 resists and reverses movement of a patient's buttocks toward the foot end 38 of the bed 10 when the head deck section 28 has stopped moving at a desired raised position, as suggested in FIGS. 10-12. Specifically, when the head deck section 28 is moved to a desired raised position as measured by the position sensor 76, the controller 72 directs the manifold 84 to begin operate so that the variable-shape seat cushion 44 foams a moving wave front 101 configured to resist and reverse movement of a patient's buttocks toward the foot end 38 of the bed 10. In some embodiments, the controller 72 intermittently or continuously forms additional wave fronts 101 while the head deck section 28 is in the raised position to resist and reverse movement of a patient's buttocks toward the foot end 38 of the bed 10.

Illustratively, the wave front 101 is created when the controller 72 directs the manifold 96 to inflate the seat bladders 64, 66 of the variable-shape seat cushion 44 to form the wave front 101 as shown in FIG. 10. In the exemplary embodiment of FIG. 10, to form the wave front 101 shown in FIG. 10, the seat bladders 66, 64 furthest from the head bladder 42 are inflated to a pressure greater than the pressure in the seat bladders 62, 60 nearest the head bladder 42. The increased pressure in seat bladders 66, 64 cause seat bladders 66, 64 furthest from the head bladder 42 to be taller than seat bladders 62, 60 nearest the head bladder 42. In other embodiments, the wave front 101 may be created by the controller 72 directing the manifold 96 to inflate the seat bladder 66 of the variable-shape seat cushion 44.

Once the wave front 101 is formed, the controller 72 directs the manifold 96 to begin inflation of seat bladder 62 while beginning deflation of seat bladder 66 to move the wave front 101 of the seat-supporting section 54 toward the head-supporting section 52 of the mattress 14 as shown, for example, in FIG. 11. Inflation of the seat bladder 62 results in the seat bladder 62 being increased in height so that the seat bladder 62 is taller than the seat bladder 60 nearest the head bladder 42. Deflation of seat bladder 66 results in the seat bladder 66 being reduced in height so that the seat bladder 66 is shorter than the seat bladder 64.

Next, the controller 72 directs the manifold 96 to begin to deflate the seat bladder 64 so that the wave front 101 is reduced before pinching a patient's buttocks between the seat-supporting section 54 and the head-supporting section 52 of the mattress 14 as shown, for example, in FIG. 12. Deflation of the seat bladder 64 results in the seat bladder 64 being reduced in height so that seat bladder 64 is about the same height as the seat bladder 62.

Finally, the controller 72 directs the manifold 96 to deflate the seat bladders 62, 64 so that the variable-shape seat cushion 44 returns to a substantially flat configuration wherein the seat bladders 60, 62, 64, 66 each have about the same pressure. The steps of inflating and deflating the seat bladders 60, 62, 64, 66 may be repeated to form a recurring wave front 101 in seat-supporting section 54 of the mattress 14 that resists and reverses movement of a patient's buttocks toward the foot end 38 of the bed 10. The seat bladder 60 nearest the head-supporting section 52 of the mattress 14 is illustratively deflated so that a patient's buttocks are not pinched between the seat-supporting section 54 and the head-supporting section 52 of the mattress 14. In other embodiments, the seat bladder 60 nearest the head-supporting section 52 of the mattress 14 may be left at its original pressuring while the wave front 101 is created.

In other embodiments, the wave front 101 may be created by the controller 72 directing the manifold 96 to inflate the seat bladder 66 of the variable-shape seat cushion 44 so that the seat bladder 66 is taller than the other seat bladders 64, 62, 60. In some such embodiments, the controller 72 may inflate and deflate the seat bladders 60, 62, 64, 66 so that the wave front 101 moves toward the head bladder 42.

In a fourth mode of operation, the controller 72 is configured to dynamically change the shape of the variable-shape seat cushion 44 so that the seat-supporting section 54 of the mattress 14 resists and reverses movement of a patient's buttocks toward the foot end 38 of the bed 10 during movement of the head deck section 28 from the lowered position toward the raised position. Specifically, when the head deck section 28 begins moving toward a desired raised position, the controller 72 directs the manifold 84 to begin operating so that the variable-shape seat cushion 44 forms the moving wave front 101 configured to resist and reverse movement of a patient's buttocks toward the foot end 38 of the bed 10. The wave front 101 formed during movement of the head deck section 28 toward the raised position is illustratively accomplished in a manner substantially similar to that described with regard to the third mode of operation.

In some embodiments of the fourth mode of operation, the controller 72 may intermittently or continuously direct the variable-shape cushion 44 to form additional wave fronts 101 while the head deck section 28 continues toward the raised position and may continue to form wave fronts 101 at predetermined intervals until the head deck section 28 returns to the lowered position. In some embodiments of the fourth mode of operation, the controller 72 may direct the variable shape cushion 44 to one or more wave fronts 101 during movement of the head deck section 28 away from a raised position toward the lowered position.

Although the invention has been described with reference to the preferred embodiments, variations and modifications exist within the scope and spirit of the invention as described and as defined in the following claims.

1. A patient support apparatus comprising
a deck including a seat deck section and a head deck section movable between a lowered position and a raised position,
a support structure supported on the deck, the support structure including a variable-shape cushion that is selectively configurable to a plurality of shapes, and
a control system coordinating configuration of the variable-shape cushion with movement of the head deck section between the lowered position and the raised position such that movement of the head deck section upwardly causes the variable-shape cushion to be configured to resist shifting of a patient's buttocks.

2. The patient support apparatus of claim 1, wherein the apparatus further comprises a lower frame and an upper frame movable relative to the lower frame.

3. The patient support apparatus of claim 2, wherein the deck is supported on the upper frame for pivotal movement relative thereto.

4. The patient support apparatus of claim 1, wherein the control system coordinates configuration of the variable-shape cushion such that the variable-shape cushion is no longer in a configuration to resist shifting of a patient's buttocks after termination of the upward movement.

5. The patient support apparatus of claim 1, wherein the control system coordinates configuration of the variable-shape cushion such that the variable-shape cushion remains in a configuration to resist shifting of a patient's buttocks until the head deck section returns to the lowered position.

6. The patient support apparatus of claim 1, wherein the control system coordinates configuration of the variable-shape cushion with the movement of the head deck section such that the degree of variation of the variable-shape cushion is proportional to the angle between the head deck section and the seat deck section.

7. The patient support apparatus of claim 1, wherein the variable-shape cushion includes at least one inflatable bladder.

8. The patient support apparatus of claim 7, wherein the control system includes a controller and an air system having a source of pressurized air, a manifold, and an exhaust, the control system configured to control flow of air from the source of pressurized air through the manifold to the variable-shape cushion.

9. The patient support apparatus of claim 8, wherein the control system coordinates inflation of the bladder with movement of the head deck section.

10. The patient support apparatus of claim 9, wherein at least one inflatable bladder of the variable-shape cushion includes a plurality of transversely oriented bladders that are inflated to varying degrees so that the upper surface of the seat-support section forms an incline characterized in that the seat-support section near a foot end of the patient support apparatus is higher than the seat-support section near a head end of the patient support apparatus.

11. A patient support apparatus comprising
a deck including a seat deck section and a head deck section movable between a lowered position and a raised position,
a support structure supported on the deck, the support structure including a variable-shape cushion that is selectively configurable to a plurality of shapes, and
a control system coordinating configuration of the variable-shape cushion with movement of the head deck section to a plurality of positions between the lowered position and the raised position such that the variable-shape cushion forms a wave front shifting a patient's buttocks toward the head support section.

12. The patient support apparatus of claim 11, wherein the apparatus further comprises a lower frame and an upper frame movable relative to the lower frame.

13. The patient support apparatus of claim 12, wherein the deck is supported on the upper frame for pivotal movement relative thereto.

14. The patient support apparatus of claim 11, wherein the control system coordinates configuration of the variable-shape cushion to cycle once to shift a patient's buttocks when the position of the head deck section exceeds a threshold angle relative to the upper frame.

15. The patient support apparatus of claim 11, wherein the control system coordinates configuration of the variable-shape cushion to intermittently cycle to shift a patient's buttocks when the position of the head deck section exceeds a threshold angle relative to the upper frame.

16. The patient support apparatus of claim 11, wherein the control system coordinates configuration of the variable-shape cushion to continuously cycle to shift a patient's buttocks when the position of the head deck section exceeds a threshold angle relative to the upper frame.

17. The patient support apparatus of claim 11, wherein the variable-shape cushion includes at least one inflatable bladder.

18. The patient support apparatus of claim 17, wherein the control system includes a controller and an air system including a source of pressurized air, a manifold, and an exhaust, the controller configured to control flow of air from the source of pressurized air through the manifold to the variable-shape cushion.

19. The patient support apparatus of claim 18, wherein the variable-shape cushion includes a plurality of transversely oriented bladders that are inflated sequentially beginning at an end of the variable-shape cushion closest to a foot-supporting section and reaching an end point prior to the bladder closest to the head-supporting section, each bladder is deflated after a time so that the seat-supporting section of the mattress forms a wave front that moves from an end of the seat-support section closest to a foot-supporting section of the mattress toward the end of the seat-supporting section closest to the head-supporting section.

20. The patient support apparatus of claim 19, wherein at least one inflatable bladder of the variable-shape cushion closest to the head-supporting section is deflated, lowering that portion of the top surface of the variable-shape cushion with respect to the rest of the top surface.
